(19) United States
(12) Patent Application Publication
(10) Pub. No.: US 2020/0380085 A1
(43) Pub. Date: Dec. 3, 2020

(54) Simulations with Realistic Sensor-Fusion Detection Estimates of Objects

(71) Applicant: Robert Bosch GmbH, Stuttgart (DE)

(72) Inventor: Karsten Behrendt, Sunnyvale, CA (US)

(21) Appl. No.: 16/429,381

(22) Filed: Jun. 3, 2019

(51) Int. Cl. G06F 17/50; G06N 3/08; G01S 13/93; G01S 13/86; G01S 17/93

(52) U.S. Cl. CPC G06F 17/5009; G06N 3/08; G06F 17/5095; G01S 17/936; G01S 13/867; G01S 13/865; G01S 13/931

(57) ABSTRACT

A method is implemented by a processing system with at least one computer processor. The method includes obtaining a visualization of a scene that includes a template of a simulation object within a region. The method includes generating a sensor-fusion representation of the template upon receiving the visualization as input. The method includes generating a simulation of the scene with a sensor-fusion detection estimate of the simulation object instead of the template within the region. The sensor-fusion detection estimate includes object contour data indicating bounds of the sensor-fusion representation. The sensor-fusion detection estimate represents the bounds or shape of an object as would be detected by a sensor-fusion system.

### FIELD OF THE INVENTION

This disclosure relates generally to generating realistic sensor-fusion detection estimates of objects.

### BACKGROUND

In general, there are a lot of challenges to developing an autonomous or semi-autonomous vehicle. To assist with its development, the autonomous or semi-autonomous vehicle often undergoes numerous tests based on various scenarios. In this regard, simulations are often used in many instances since they are more cost effective to perform than actual driving tests. However, there are many instances in which simulations do not accurately represent real use-cases. For example, in some cases, some simulated camera images may look more like video game images than actual camera images. In addition, there are some types of sensors, which produce sensor data that is difficult and costly to simulate. For example, radar detections are known to be difficult to simulate with accuracy. As such, simulations with these types of inaccuracies may not provide the proper conditions for the development, testing, and evaluation of autonomous and semi-autonomous vehicles.

### SUMMARY

The following is a summary of certain embodiments described in detail below. The described aspects are presented merely to provide the reader with a brief summary of these certain embodiments and the description of these aspects is not intended to limit the scope of this disclosure. Indeed, this disclosure may encompass a variety of aspects that may not be explicitly set forth below.

In an example embodiment, a system for generating a realistic simulation includes at least a non-transitory computer readable medium and a processing system. The non-transitory computer readable medium includes a visualization of a scene that includes a template of a simulation object within a region. The processing system is communicatively connected to the non-transitory computer readable medium. The processing system includes at least one processing device, which is configured to execute computer-readable data to implement a method that includes generating a sensor-fusion representation of the template upon receiving the visualization as input. The method includes generating a simulation of the scene with a sensor-fusion detection estimate of the simulation object instead of the template within the region. The sensor-fusion detection estimate includes object contour data indicating bounds of the sensor-fusion representation. The sensor-fusion detection estimate represents the bounds or shape of an object as would be detected by a sensor-fusion system.

In an example embodiment, a computer-implemented method includes obtaining, via a processing system with at least one computer processor, a visualization of a scene that includes a template of a simulation object within a region. The method includes generating, via the processing system, a sensor-fusion representation of the template upon receiving the visualization as input. The method includes generating, via the processing system, a simulation of the scene with a sensor-fusion detection estimate of the simulation object instead of the template within the region. The sensor-fusion detection estimate includes object contour data indicating bounds of the sensor-fusion representation. The sensor-fusion detection estimate represents the bounds or shape of an object as would be detected by a sensor-fusion system.

In an example embodiment, a non-transitory computer readable medium includes computer-readable data that, when executed by a computer processor, is configured to implement a method. The method includes obtaining a visualization of a scene that includes a template of a simulation object within a region. The method includes generating a sensor-fusion representation of the template upon receiving the visualization as input. The method includes generating a simulation of the scene with a sensor-fusion detection estimate of the simulation object instead of the template within the region. The sensor-fusion detection estimate includes object contour data indicating bounds of the sensor-fusion representation. The sensor-fusion detection estimate represents the bounds or shape of an object as would be detected by a sensor-fusion system.

These and other features, aspects, and advantages of the present invention are discussed in the following detailed description in accordance with the accompanying drawings throughout which like characters represent similar or like parts.

### BRIEF DESCRIPTION OF THE DRAWINGS

FIG. 1 is a conceptual diagram of a non-limiting example of a simulation system according to an example embodiment of this disclosure.

FIG. 2 is a conceptual flowchart of a process for developing a machine-learning model for the simulation system of FIG. 1 according to an example embodiment of this disclosure.

FIG. 3 is an example of a method for training the machine learning model of FIG. 2 according to an example embodiment of this disclosure.

FIG. 4 is an example of a method for generating simulations with realistic sensor-fusion detection estimates of objects according to an example embodiment of this disclosure.

FIG. 5A is a conceptual diagram of a single object in relation to sensors according to an example embodiment of this disclosure.

FIG. 5B is a diagram of a sensor-fusion detection of the object of FIG. 5A according to an example embodiment of this disclosure.

FIG. 6A is a conceptual diagram of multiple objects in relation to at least one sensor according to an example embodiment of this disclosure.

FIG. 6B is a diagram of a sensor-fusion detection based on the multiple objects of FIG. 6A according to an example embodiment of this disclosure.

FIG. 7 is a diagram that shows a superimposition of various data relating to objects of a geographic region according to an example embodiment of this disclosure.

FIG. 8A is a diagram of a non-limiting example of a scene with objects according to an example embodiment of this disclosure.

FIG. 8B is a diagram of a non-limiting example of the scene of FIG. 8A with sensor-based data in place of the objects according to an example embodiment of this disclosure.

### DETAILED DESCRIPTION

The embodiments described herein, which have been shown and described by way of example, and many of their advantages will be understood by the foregoing description, and it will be apparent that various changes can be made in the form, construction, and arrangement of the components without departing from the disclosed subject matter or without sacrificing one or more of its advantages. Indeed, the described forms of these embodiments are merely explanatory. These embodiments are susceptible to various modifications and alternative forms, and the following claims are intended to encompass and include such changes and not be limited to the particular forms disclosed, but rather to cover all modifications, equivalents, and alternatives falling within the spirit and scope of this disclosure.

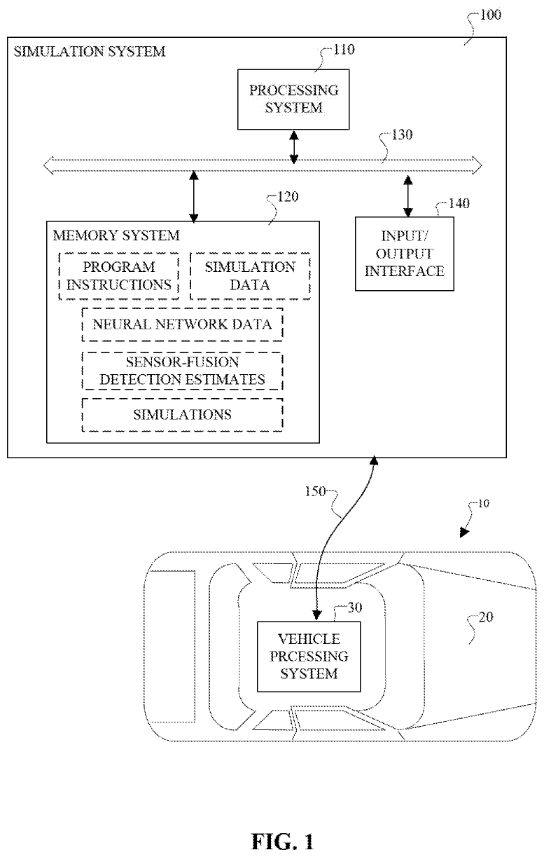

FIG. 1 is a conceptual diagram of an example of a simulation system 100, which is configured to generate simulations with realistic sensor-fusion detection estimates. In an example embodiment, the simulation system 100 has a processing system 110, which includes at least one processor. In this regard, for example, the processing system 110 includes at least a central processing unit, (CPU), a graphics processing unit (GPU), an application-specific integrated circuit (ASIC), any suitable processing device, hardware technology, or any combination thereof. In an example embodiment, the processing system 110 is configured to perform a variety of functions, as described herein, such that simulations with realistic sensor-fusion detection estimates are generated and transmitted to any suitable application system 10.

In an example embodiment, the simulation system 100 includes a memory system 120, which comprises any suitable memory configuration that includes at least one non-transitory computer readable medium. For example, the memory system 120 includes semiconductor memory, random access memory (RAM), read only memory (ROM), virtual memory, electronic storage devices, optical storage devices, magnetic storage devices, memory circuits, any suitable memory technology, or any combination thereof. The memory system 120 is configured to include local, remote, or both local and remote components with respect to the simulation system 100. The memory system 120 stores various computer readable data. For example, in FIG. 1, the computer readable data includes at least program instructions, simulation data, machine-learning data (e.g., neural network data), sensor-fusion detection estimates, simulations, or any combination thereof. Also, in an example embodiment, the memory system 120 includes other relevant data, which relates to the functionalities described herein. In general, the memory system 120 is configured to provide the processing system 110 with access to various computer readable data such that the processing system 110 is enabled to at least generate various simulations of various scenarios in various environmental regions that include realistic sensor-fusion detection estimates of objects. These realistic simulations are then transmitted to and executed by one or more components of the application system 10.

In an example embodiment, the simulation system 100 also includes at least a communication network 130, an input/output interface 140, and other functional modules. The communication network 130 is configured to enable communications between and/or among one or more components of the simulation system 100. The communication network 130 includes wired technology, wireless technology, any suitable communication technology, or any combination thereof. For example, the communication network 130 enables the processing system 110 to communicate with the memory system 120 and the input/output interface 140. The input/output interface 140 is configured to enable communication between one or more components of the simulation system 100 and one or more components of the application system 10. For example, in FIG. 1, the input/output interface 140 is configured to provide an interface that enables simulations with realistic sensor-fusion detection estimates to be output to the vehicle processing system 30 via a communication link 150. In an example embodiment, the communication link 150 is any suitable communication technology that enables data communication between the simulation system 100 and the application system 10. Additionally, although not shown in FIG. 1, the simulation system 100 is configured to include other functional components (e.g., operating system, etc.), which include computer components that are known and not described herein.

In an example embodiment, the application system 10 is configured to receive realistic simulations from the simulation system 100. In an example embodiment, for instance, the application system 10 relates to a vehicle 20, which is autonomous, semi-autonomous, or highly-autonomous. Alternatively, the simulations can be applied to a non-autonomous vehicle. For example, in FIG. 1, the simulation system 100 provides simulations to one or more components of a vehicle processing system 30 of the vehicle 20. Non-limiting examples of one or more components of the vehicle processing system 30 include a trajectory system, a motion control system, a route-planning system, a prediction system, a navigation system, any suitable system, or any combination thereof. Advantageously, with these simulations, the vehicle 20 is provided with realistic input data without having to go on real-world drives, thereby leading to cost-effective development and evaluation of one or more components of the vehicle processing system 30.

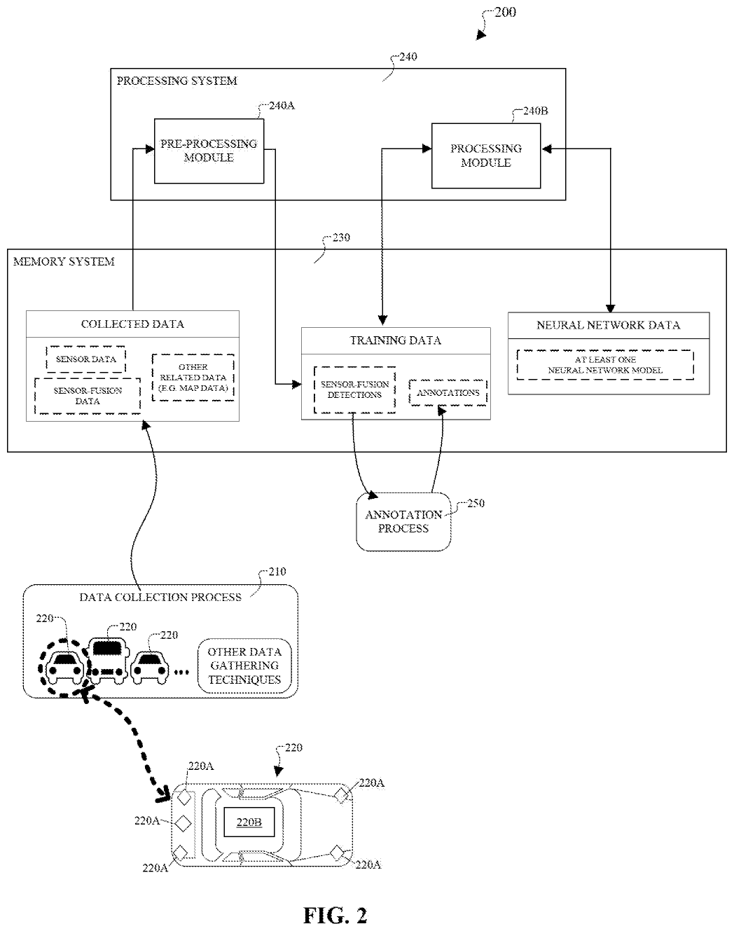

FIG. 2 is a conceptual flowchart of a process 200 involved in developing machine-learning data (e.g., neural network data with at least one neural network model) such that the processing system 110 is configured to generate realistic sensor-fusion detection estimates of objects according to an example embodiment. The process 200 ensures that the machine-learning model is trained with a sufficient amount of proper training data. In this case, as shown in FIG. 2, the training data includes real-world sensor-fusion detections and their corresponding annotations. In an example embodiment, the training data is based on collected data, which is harvested via a data collection process 210 that includes a sufficiently large amount of data collections.

In an example embodiment, the data collection process 210 includes obtaining and storing a vast amount of collected data from the real-world. More specifically, for instance, the data collection process 210 includes collecting sensor-based data (e.g., sensor data, sensor-fusion data, etc.) via various sensing devices that are provided on various mobile machines during various real-world drives. In this regard, for example, FIG. 2 illustrates a non-limiting example of a vehicle 220, which is configured to harvest sensor-based data from the real-world and provide a version of this collected data to the memory system 230. In this example, the vehicle 220 includes at least one sensor system with various sensors 220A to detect an environment of the vehicle 220. In this case, the sensor system includes ‘n’ number of sensors 220A, where ‘n’ represents an integer number greater than 2. Non-limiting examples of the various sensors 220A include a light detection and ranging (LIDAR) sensor, a camera system, a radar system, an infrared system, a satellite-based sensor system (e.g., global navigation satellite system (GNSS), global positioning satellite (GPS), etc.), any suitable sensor, or any combination thereof.

In an example embodiment, the vehicle 220 includes a vehicle processing system 220B with non-transitory computer-readable memory. The computer-readable memory is configured to store various computer-readable data including program instructions, sensor-based data (e.g., raw sensor data, sensor-fusion data, etc.), and other related data (e.g., map data, localization data, etc.). The other related data provides relevant information (e.g., context) regarding the sensor-based data. In an example embodiment, the vehicle processing system 220B is configured to process the raw sensor data and the other related data. Additionally or alternatively, the processing system 220B is configured to generate sensor-fusion data based on the processing of the raw sensor data and the other related data. After obtaining this sensor-based data and other related data, the processing system 220B is configured to transmit or transfer a version of this collected data from the vehicle 220 to the memory system 230 via communication technology, which includes wired technology, wireless technology, or both wired and wireless technology.

In an example embodiment, the data collection process 210 is not limited to this data collection technique involving vehicle 220, but can include other data gathering techniques that provide suitable real-world sensor-based data. In addition, the data collection process 210 includes collecting other related data (e.g. map data, localization data, etc.), which corresponds to the sensor-based data that is collected from the vehicles 220. In this regard, for example, the other related data is advantageous in providing context and/or further details regarding the sensor-based data.

In an example embodiment, the memory system 230 is configured to store the collected data in one or more non-transitory computer readable media, which includes any suitable memory technology in any suitable configuration. For example, the memory system 230 includes semiconductor memory, RAM, ROM, virtual memory, electronic storage devices, optical storage devices, magnetic storage devices, memory circuits, cloud storage system, any suitable memory technology, or any combination thereof. For instance, in an example embodiment, the memory system 230 includes at least non-transitory computer readable media in at least a computer cluster configuration.

In an example embodiment, after this collected data has been stored in the memory system 230, then the process 200 includes ensuring that a processing system 240 trains the machine-learning model with appropriate training data, which is based on this collected data. In an example embodiment, the processing system 240 includes at least one processor (e.g., CPU, GPU, processing circuits, etc.) with one or more modules, which include hardware, software, or a combination of hardware and software technology. For example, in FIG. 2, the processing system 240 contains one or more processors along with software, which include at least a pre-processing module 240A and a processing module 240B. In this case, the processing system 240 executes program instructions, which are stored in the memory system 230, the processing system 240 itself (via local memory), or both the memory system 230 and the processing system 240.

In an example embodiment, upon obtaining the collected data, the pre-processing module 240A is configured to provide suitable training data for the machine-learning model. In FIG. 2, for instance, the pre-processing module 240A is configured to generate sensor-fusion detections upon obtaining the sensor-based data as input. More specifically, for example, upon receiving raw sensor data, the pre-processing module 240A is configured to generate sensor-fusion data based on this raw sensor data from the sensors of the vehicle 220. In this regard, for example, the sensor-fusion data refers to a fusion of sensor data from various sensors, which are sensing an environment at a given instance. In an example embodiment, the method is independent of the type of fusion approach and is implementable with early fusion and/or late fusion. The generation of sensor-fusion data is advantageous, as a view based on a combination of sensor data from various sensors is more complete and reliable than a view based on sensor data from an individual sensor. Upon generating or obtaining this sensor-fusion data the pre-processing module 240A is configured to identify sensor-fusion data that corresponds to an object. In addition, the pre-processing module 240A is configured to generate a sensor-fusion detection, which includes a representation of the general bounds of sensor-fusion data that relates to that identified object. With this pre-processing, the processing module 240B is enabled to handle these sensor-fusion detections, which identify objects, with greater ease and quickness compared to unbounded sensor-fusion data, which correspond to those same objects.

In an example embodiment, the processing module 240B is configured to train at least one machine-learning model to generate sensor-fusion detection estimates for objects based on real-world training data according to real-use cases. In FIG. 2, for instance, the processing module 240B is configured to train the machine-learning model to generate sensor-fusion detection estimates for the objects based on training data, which includes real-world sensor-fusion detections together with corresponding annotations. More specifically, upon generating the real-world sensor-fusion detections, the process 200 includes an annotation process 250. The annotation process 250 includes obtaining annotations, which are objective and valid labels that identify these sensor-fusion detections in relation to the objects that they represent. In an example embodiment, for instance, the annotations are provided by annotators, such as skilled humans (or any reliable and verifiable technological means). More specifically, these annotators provide labels for identified sensor-fusion detections of objects (e.g., building, tree, pedestrian, signs, lane-markings) among the sensor-fusion data. In addition, the annotators are enabled to identify sensor-fusion data that correspond to objects, generate sensor-fusion detections for these objects, and provide labels for these sensor-fusion detections. These annotations are stored with their corresponding sensor-fusion detections of objects as training data in the memory system 230. With this training data, the processing module 240B is configured to optimize a machine-learning architecture, its parameters, and its weights for a given task.

In an example embodiment, the processing module 240B is configured to train machine-learning technology (e.g., machine-learning algorithms) to generate sensor-fusion detection estimates for objects in response to receiving object data for these objects. In this regard, for example, the memory system 230 includes machine-learning data such as neural network data. More specifically, in an example embodiment, for instance, the machine-learning data includes a generative adversarial network (GAN). In an example embodiment, the processing module 240B is configured to train the GAN model to generate new objects based on different inputs. For example, the GAN is configured to transform one type of image (e.g., a visualization, a computer graphics-based image, etc.) into another type of image (e.g., a real-looking image such as a sensor-based image). The GAN is configured to modify at least parts of an image. As a non-limiting example, for instance, the GAN is configured to transform or replace one or more parts (e.g., extracted object data) of an image with one or more items (e.g., sensor-fusion detection estimates). In this regard, for example, with the appropriate training, the GAN is configured to change at least one general attribute of an image.

In FIG. 2, for instance, the processing module 240B is configured to train the GAN model to transform extracted object data into sensor-fusion detection estimates. Moreover, the processing module 240B trains the GAN model to perform these transformations directly in response to object data without the direct assistance or execution of a sensor system, a perception system, or a sensor-fusion system. In this regard, the processing module 240B, via the GAN, generates realistic sensor-fusion detection estimates directly from object data without having to simulate sensor data (or generate sensor data estimates) for each sensor on an individual basis. This feature is advantageous as the processing module 240B circumvents the burdensome process of simulating image data from a camera system, LIDAR data from a LIDAR system, infrared data from an infrared sensor, radar data from a radar system, and/or other sensor data from other sensors on an individual basis in order to generate realistic input for an application system 10 (e.g., vehicle processing system 30). This feature also overcomes the difficulty in simulating radar data via a radar system, as this individual step is not performed by the processing module 240B. That is, the processing module 240B trains the GAN to generate realistic sensor-fusion detection estimates in direct response to receiving object data as input. Advantageously, this generation of sensor-fusion detection estimates improves the rate and costs associated with generating realistic sensor-based input for the development and evaluation of one or more components of the application system 10.

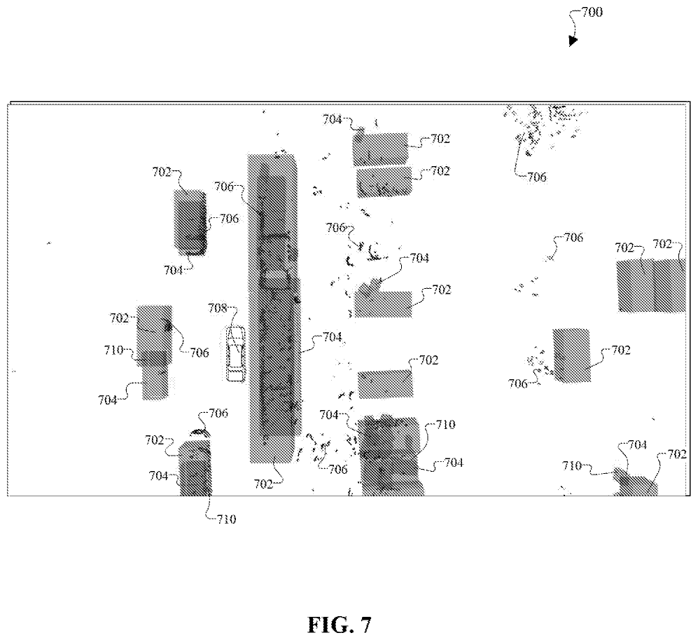

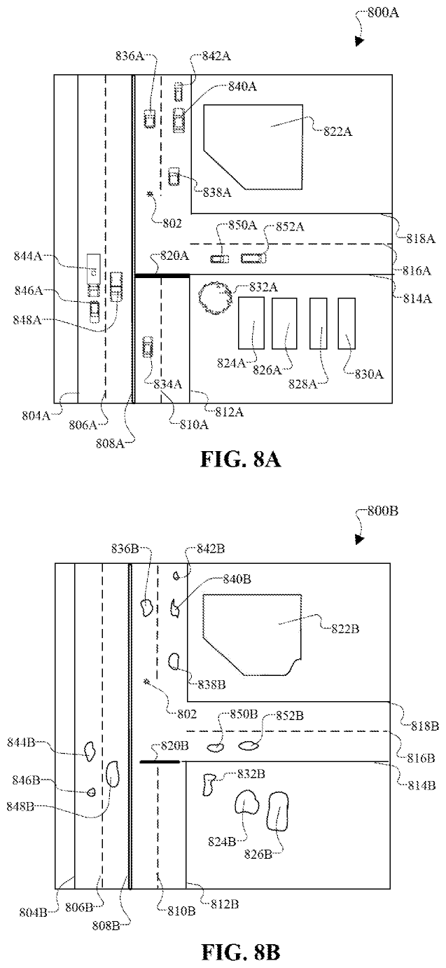

In an example embodiment, the generation of sensor-fusion detection estimates of objects include the generation of sensor-fusion representations, which indicate bounds of detections corresponding to those objects. More specifically, in FIG. 2, the processing system 240B, via the GAN, is configured to generate sensor-fusion detection estimates of objects comprising representations of detections of those objects that include one or more data structures, graphical renderings, any suitable detection agents, or any combination thereof. For instance, the processing system 240B is configured to train the GAN to generate sensor-fusion detection estimates that include polygonal representations (e.g., box or box-like representations as shown in FIG. 7). Alternatively, the processing system 240B, via the GAN, is configured to generate sensor-fusion detection estimates that include complete contours (e.g., contours as shown in FIG. 8B).

In an example embodiment, the processing module 240B is configured to train the GAN to transform the extracted object data corresponding to the objects into sensor-fusion detection estimates, separately or collectively. For example, the processing module 240B is configured to train the GAN to transform object data of selected objects into sensor-fusion detection estimates on an individual basis (e.g., one at a time). Also, the processing module 240B is configured to train the GAN to transform one or more sets of object data of selected objects into sensor-fusion detection estimates, simultaneously. As another example, instead of performing transformations, the processing module 240B is configured to train the GAN to generate sensor-fusion detection estimates from object data of selected objects on an individual basis (e.g., one at a time). Also, the processing module 240B is configured to train the GAN to generate sensor-fusion detection estimates from object data of one or more sets of object data of selected objects, simultaneously.

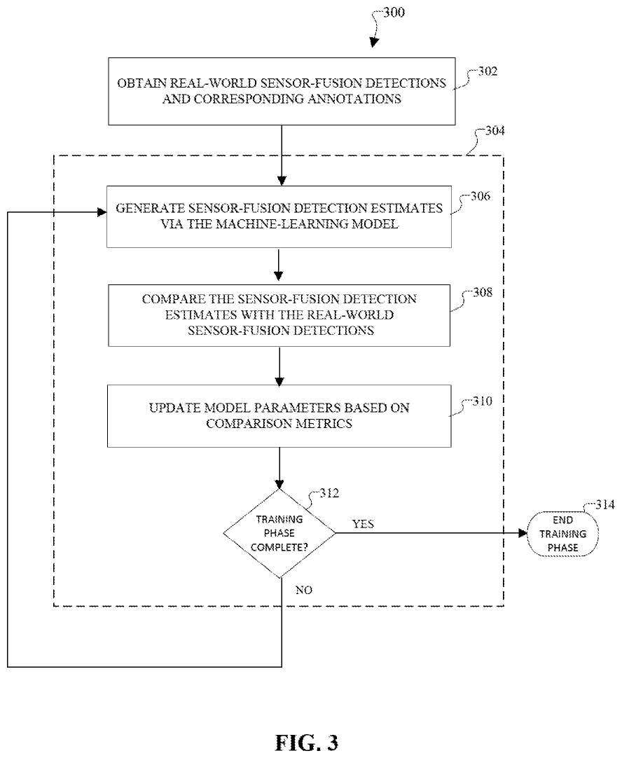

FIG. 3 is an example of a method 300 for training the machine learning model to generate the sensor-fusion detection estimates based on real-world training data. In an example embodiment, the processing system 240 (e.g. the processing module 240B) is configured to perform the method shown in FIG. 3. In an example embodiment, the method 300 includes at least step 302, step 304, step 306, step 308, and step 310. In addition, the method can also include steps 312 and 314.

At step 302, in an example embodiment, the processing system 240 is configured to obtain training data. For instance, as shown in FIG. 2, the training data includes real-world sensor-fusion detections of objects and corresponding annotations. The annotations are valid labels that identify the real-world sensor-fusion detections in relation to the corresponding real-world objects that they represent. In this example, for instance, the annotations are input and verified by skilled humans. Upon obtaining this training data, the processing system 240 is configured to proceed to step 304.

At step 304, in an example embodiment, the processing system 240 is configured to train the neural network to generate realistic sensor-fusion detection estimates. The processing system 240 is configured to train the neural network (e.g., at least one GAN model) based on training data, which includes at least real-world sensor-fusion detections of objects and corresponding annotations. In an example embodiment, the training includes steps 306, 308, and 310. In addition, the training includes determining whether or not this training phase is complete, as shown at step 312. Also, the training can include other steps, which are not shown in FIG. 3 provided that the training results in a trained neural network model, which is configured to generate realistic sensor-fusion detection estimates as described herein.

At step 306, in an example embodiment, the processing system 240 is configured to generate sensor-fusion detection estimates via at least one machine-learning model. In an example embodiment, the machine-learning model includes a GAN model. In this regard, upon receiving the training data, the processing system 240 is configured to generate sensor-fusion detection estimates via the GAN model. In an example embodiment, a sensor-fusion detection estimate of an object provides a representation that indicates the general bounds of sensor-fusion data that is identified as that object. Non-limiting examples of these representations include data structures, graphical renderings, any suitable detection agents, or any combination thereof. For instance, the processing system 240 is configured to generate sensor-fusion detection estimates for objects that include polygonal representations, which comprise data structures with polygon data (e.g., coordinate values) and/or graphical renderings of the polygon data that indicate the polygonal bounds of detections amongst the sensor-fusion data for those objects. Upon generating sensor-fusion detection estimates for objects, the processing system 240 is configured to proceed to step 308.

At step 308, in an example embodiment, the processing system 240 is configured to compare the sensor-fusion detection estimates with the real-world sensor-fusion detections. In this regard, the processing system 240 is configured to determine discrepancies between the sensor-fusion detection estimates of objects and the real-world sensor-fusion detections of those same objects. For example, the processing system 240 is configured to perform at least one difference calculation or loss calculation based on a comparison between a sensor-fusion detection estimate and a real-world sensor-fusion detection. This feature is advantageous in enabling the processing system 240 to fine-tune the GAN model such that a subsequent iteration of sensor-fusion detection estimates are more realistic and more attuned to the real-world sensor-fusion detections than the current iteration of sensor-fusion detection estimates. Upon performing this comparison, the processing system 240 is configured to proceed to step 310.

At step 310, in an example embodiment, the processing system 240 is configured to update the neural network. More specifically, the processing system 240 is configured to update the model parameters based on comparison metrics obtained from the comparison, which is performed at step 308. For example, the processing system 240 is configured to improve the trained GAN model based on results of one or more difference calculations or loss calculations. Upon performing this update, the processing system 240 is configured to proceed to step 306 to further train the GAN model in accordance with the updated model parameters upon determining that the training phase is not complete at step 312. Alternatively, the processing system is configured to end this training phase at step 314 upon determining that this training phase is sufficient and/or complete at step 312.

At step 312, in an example embodiment, the processing system 240 is configured to determine whether or not this training phase is complete. In an example embodiment, for instance, the processing system 240 is configured to determine that the training phase is complete when the comparison metrics are within certain thresholds. In an example embodiment, the processing system 240 is configured to determine that the training phase is complete upon determining that the neural network (e.g., at least one GAN model) has been trained with a predetermined amount of training data (or a sufficient amount of training data). In an example embodiment, the training phase is determined to be sufficient and/or complete when accurate and reliable sensor-fusion detection estimates are generated by the processing system 240 via the GAN model. In an example embodiment, the processing system 240 is configured to determine that the training phase is complete upon receiving a notification that the training phase is complete.

At step 314, in an example embodiment, the processing system 240 is configured to end this training phase. In an example embodiment, upon completing this training phase, the neural network is deployable for use. For example, in FIG. 1, the simulation system 100 and/or processing system 110 is configured to obtain at least one trained neural network model (e.g., trained GAN model) from the memory system 230 of FIG. 2. Also, in an example embodiment, as shown in FIG. 1, the simulation system 100 is configured to employ the trained GAN model to generate or assist in the generation of realistic sensor-fusion detection estimates for simulations.

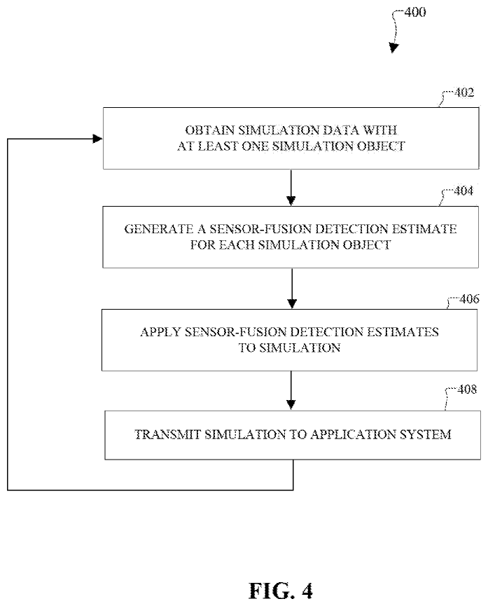

FIG. 4 is an example of a method 400 for generating simulations with realistic sensor-fusion detection estimates of objects according to an example embodiment. In an example embodiment, the simulation system 100, particularly the processing system 110, is configured to perform at least each of the steps shown in FIG. 4. As aforementioned, once the simulations are generated, then the simulation system 100 is configured to provide these simulations to the application system 10, thereby enabling cost-effective development and evaluation of one or more components of the application system 10.

At step 402, in an example embodiment, the processing system 110 is configured to obtain simulation data, which includes a simulation program with at least one visualization of at least one simulated scene. In an example embodiment, for instance, the visualization of the scene includes at least a three-channel pixel image. More specifically, as a non-limiting example, a three-channel pixel image is configured to include, for example, in any order, a first channel with a location of the vehicle 20, a second channel with locations of simulation objects (e.g., dynamic simulation objects), and a third channel with map data. In this case, the map data includes information from a high-definition map. The use of a three-channel pixel image in which the simulation objects are provided in a distinct channel is advantageous in enabling efficient handling of the simulation objects. Also, in an example embodiment, each visualization includes a respective scene, scenario, and/or condition (e.g., snow, rain, etc.) from any suitable view (e.g., top view, side view, etc.). For example, a visualization of the scene with a two-dimensional (2D) top view of template versions of simulation objects within a region is relatively convenient and easy to generate compared to other views while also being relatively convenient and easy for the processing system 110 to handle.

In an example embodiment, the simulation objects are representations of real-world objects (e.g., pedestrians, buildings, animals, vehicles, etc.), which may be encountered in a region of that environment. In an example embodiment, these representations are model versions or template versions (e.g. non-sensor-based versions) of these real-world objects, thereby not being accurate or realistic input for the vehicle processing system 30 compared to real-world detections, which are captured by sensors 220A of the vehicle 220 during a real-world drive. In an example embodiment, the template version include at least various attribute data of an object as defined within the simulation. For example, the attribute data can include size data, shape data, location data, other features of an object, any suitable data, or any combination thereof. In this regard, the generation of visualizations of scenes that include template versions of simulation objects is advantageous as this allows various scenarios and scenes to be generated at a fast and inexpensive rate since these visualizations can be developed without having to account for how various sensors would detect these simulation objects in the environment. As a non-limiting example, for instance, in FIG. 8A, the simulation data includes a visualization 800A, which is a 2D top view of a geographical region, which includes roads near an intersection along with template versions of various objects, such as stationary objects (e.g., buildings, trees, fixed road features, lane-markings, etc.) and dynamic objects (e.g. other vehicles, pedestrians, etc.). Upon obtaining the simulation data, the processing system 110 performs step 404.

At step 404, in an example embodiment, the processing system 110 is configured to generate a sensor-fusion detection estimate for each simulation object. For example, in response to receiving the simulation data (e.g., a visualization of a scene) as input, the processing system 110 is configured to implement or employ at least one trained GAN model to generate sensor-fusion representations and/or sensor-fusion detection estimates in direct response to the input. More specifically, the processing system 110 is configured to implement a method to provide simulations with sensor-fusion detection estimates. In this regard, for instance, two different methods are discussed below in which a first method involves image-to-image transformation and the second method involves image-to-contour transformation.

As a first method, in an example embodiment, the processing system 110 together with the trained GAN model is configured to perform image to image transformation such that a visualization of a scene with at least one simulation object is transformed into an estimate of a sensor-fusion occupancy map with sensor-fusion representations of the simulation object. In this case, the estimate of the sensor-fusion occupancy map is a machine-learning based representation of a real-world sensor-fusion occupancy map that a mobile machine (e.g., vehicle 20) would generate during a real-world drive. For example, the processing system 110 is configured to obtain simulation data with at least one visualization of at least one scene that includes a three-channel image or any suitable image. More specifically, in an example embodiment, the processing system 110, via the trained GAN model, is configured to transform the visualization of a scene with simulation objects into a sensor-fusion occupancy map (e.g., 512×512 pixel image or any suitable image) with corresponding sensor-fusion representations of those simulation objects. As a non-limiting example, for instance, the sensor-fusion occupancy map includes sensor-fusion representations with one or more pixels having pixel data (e.g., pixel colors) that indicates object occupancy (and/or probability data relating to object occupancy for each pixel). In this regard, for example, upon obtaining a visualization of a scene (e.g., image 800A of FIG. 8A), the processing system 110 is configured to generate an estimate of a sensor-fusion occupancy map that is similar to image 800B of FIG. 8B in that sensor-fusion representations correspond to detections of simulation objects in a realistic manner based on the scenario, but different than the image 800B in that the sensor-fusion occupancy map does not yet include object contour data for the corresponding simulation objects as shown in FIG. 8B.

Also, for this first method, after generating the sensor-fusion occupancy map with sensor-fusion representations corresponding to simulation objects, the processing system 110 is configured to perform object contour extraction. More specifically, for example, the processing system 110 is configured to obtain object information (e.g., size and shape data) from the occupancy map. In addition, the processing system 110 is configured to identify pixels with an object indicator or an object marker as being sensor-fusion data that corresponds to a simulation object. For example, the processing system 110 is configured to identify one or more pixel colors (e.g., dark pixel colors) as having a relatively high probability of being sensor-fusion data that represents a corresponding simulation object and cluster those pixels together. Upon identifying pixels of a sensor-fusion representation that corresponds to a simulation object, the processing system 110 is then configured to obtain an outline of the clusters of pixels of sensor-fusion data that correspond to the simulation objects and present the outline as object contour data. In an example embodiment, the processing system 110 is configured to provide the object contour data as a sensor-fusion detection estimate for the corresponding simulation object.

As a second method, in an example embodiment, the processing system 110 is configured to receive a visualization of a scene with at least one simulation object. For instance, as a non-limiting example of input, the processing system 110, via the at least one trained GAN model, is configured to receive a visualization of a scene that includes at least one simulation object in a center region with a sufficient amount of contextual information regarding the environment. As another example of input, the processing system 110, via the at least one trained GAN model, is configured to receive a visualization of a scene that includes at least one simulation object along with additional information provided in a data vector. For instance, in a non-limiting example, the data vector is configured to include additional information relating to the simulation object such as a distance from that simulation object to the vehicle 10, information regarding other vehicles between the simulation object and the vehicle 10, environment condition (e.g., weather information), other relevant information, or any combination thereof.

Also, for this second method, upon receiving simulation data as input, the processing system 110 via the trained GAN model is configured to transform each simulation object from the visualization directly into a corresponding sensor-fusion detection estimate, which includes object contour data. In this regard, for instance, the object contour data includes a suitable number of points that identify an estimate of an outline of bounds of the sensor-fusion data that represents that simulation object. For instance, as a non-limiting example, the processing system 110 is configured to generate object contour data, which is scaled in meters for 2D space and includes the following points: (1.2, 0.8), (1.22, 0.6), (2.11, 0.46), (2.22, 0.50), (2.41, 0.65), and (1.83, 0.70). In this regard, the object contour data advantageously provides an indication of estimates of bounds of sensor-fusion data that represent object detections as would be detected by a sensor-fusion system in an efficient manner with relatively low memory consumption.

For the first method or the second method associated with step 404, the processing system 110 is configured to generate or provide an appropriate sensor-fusion detection estimate for each simulation object in accordance with how a real-world sensor-fusion system would detect such an object in that scene. In an example embodiment, the processing system 110 is configured to generate each sensor-fusion detection estimate for each simulation object on an individual basis. As another example, the processing system 110 is configured to generate or provide sensor-fusion detection estimates for one or more sets of simulation objects at the same time. As yet another example, the processing system 110 is configured to generate or provide sensor-fusion detection estimates for all of the simulation objects simultaneously. In an example embodiment, the processing system 110 is configured to provide object contour data as sensor-fusion detection estimates of simulation objects. After obtaining one or more sensor-fusion detection estimates, the processing system 110 proceeds to step 406.

At step 406, in an example embodiment, the processing system 110 is configured to apply the sensor-fusion detection estimates to at least one simulation step. More specifically, for example, the processing system 110 is configured to generate a simulation scene, which includes at least one visualization of at least one scene with at least one sensor-fusion detection estimate in place of the template of the simulation object. In this regard, the simulation may include the visualization of the scene with a transformation of the extracted object data into sensor-fusion detection estimates or a newly generated visualization of the scene with sensor-fusion detection estimates in place of the extracted object data. Upon applying or including the sensor-fusion detection estimates as a part of the simulation, the processing system 110 is configured to proceed to step 408.

At step 408, in an example embodiment, the processing system 110 is configured to transmit the simulation to the application system 10 so that the simulation is executed on one or more components of the application system 10, such as the vehicle processing system 30. For example, the processing system 110 is configured to provide this simulation to a trajectory system, a planning system, a motion control system, a prediction system, a vehicle guidance system, any suitable system, or any combination thereof. More specifically, for instance, the processing system 110 is configured to provide the simulations with the sensor-fusion detection estimates to a planning system or convert the sensor-fusion detection estimates into a different data structure or a simplified representation for faster processing. With this realistic input, the application system 10 is provided with information, such as feedback data and/or performance data, which enables one or more components of the application system 10 to be evaluated and improved based on simulations involving various scenarios in a cost-effective manner.

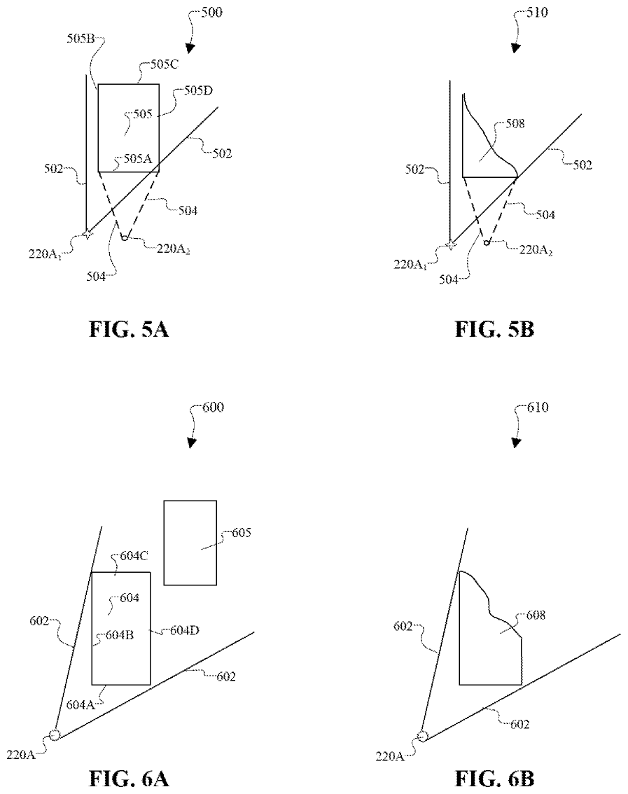

FIGS. 5A and 5B are conceptual diagrams relating to sensing an environment with respect to a sensor system according to an example embodiment. In this regard, FIG. 5A is a conceptual diagram of a real-world object 505 in relation to a sensor set, associated with respect to vehicle 220 during the data collection process 210. More specifically, FIG. 5A shows an object 505, which is detectable by a sensor set, which includes at least a first sensor 220A₁ (e.g., LIDAR sensor) with a first sensing view designated between lines 502 and a second sensor 220A₂ (e.g., camera sensor) with a second sensing view designated between lines 504. In this case, the first sensor 220A₁ and the second sensor 220A₂ have overlapping sensing ranges in which the object 505 is positioned. Meanwhile, FIG. 5B is a conceptual diagram of a sensor-fusion detection 508 of the object of FIG. 5A based on this sensor set. As shown in FIG. 5B, the sensor-fusion detection 508 includes an accurate representation of a first side 505A and a second side 505B of the object 505, but includes an inaccurate representation of a third side 505C and a fourth side 505D of the object 505. In this non-limiting scenario, the discrepancy between the actual object 505 and its sensor-fusion detection 508 may be due to the sensors, occlusion, positioning issues, any other issue, or any combination thereof. As demonstrated by FIGS. 5A and 5B, since the sensor-fusion detection 508 of the object 505 does not produce an exact match to the actual object 505 itself, the use of simulation data that includes sensor-based representations that matches or more closely resembles an actual sensor-fusion detection 508 of the object 505 is advantageous in simulating realistic sensor-based input that the vehicle 220 would receive during a real-world drive.

FIGS. 6A and 6B are conceptual diagrams relating to sensing an environment that includes two objects in relation to a sensor system. In this example, as shown in FIG. 6A, both the first object 604 and the second object 605 are in a sensing range of at least one sensor 220A. Meanwhile, FIG. 6B is a conceptual diagram of a sensor-fusion detection 608 of the first object 604 and the second object 605 based at least on sensor data of the sensor 220A. As shown in FIG. 6B, the sensor-fusion detection 608 includes an accurate representation of a first side 604A and a second side 604B of the first object 604, but includes an inaccurate representation of the third side 604C and fourth side 604D of the first object 604. In addition, as shown in FIG. 6B, the sensor 220A does not detect the second object 605 at least since the first object 604 occludes the sensor 220A from detecting the second object 606. As demonstrated by FIGS. 6A and 6B, there are a number of discrepancies between the actual scene, which includes the first object 604 and the second object 605, and its sensor-based representation, which includes the sensor-fusion detection 608. These discrepancies highlight the advantage of using simulation data with sensor-based data that matches or more closely resembles an actual sensor-fusion detection 608 of both object 604 and object 605, which the vehicle 220 would receive from its sensor system during a real-world drive.

FIG. 7 is a conceptual diagram that shows a superimposition 700 of real-world objects 702 in relation to real-world sensor-fusion detections 704 of those same objects according to an example embodiment. In addition, the superimposition 700 also includes raw sensor data 706 (e.g. LIDAR data). Also, as a reference, the superimposition 700 includes a visualization of a vehicle 708, which includes a sensor system that is sensing an environment and generating this raw sensor data 706. More specifically, in FIG. 7, the real-world objects 702 are represented by polygons of a first color (e.g. blue) and the real-world sensor-fusion detections 704 are represented by polygons of a second color (e.g., red). In addition, FIG. 7 also includes some examples of sensor-fusion detection estimates 710 (or object contour data 710). As shown by this superimposition 700, there are differences between the general bounds of the real objects 702 and the general bounds of the real-world sensor-fusion detections 704. These differences show the advantage of using simulation data that more closely matches the real-world sensor-fusion detections 704 in the development of one or more components of an application system 10 as unrealistic representations and even minor differences may result in erroneous technological development.

FIGS. 8A and 8B illustrate non-limiting examples of images with different visualizations of top-views of a geographic region according to an example embodiment. Also, for discussion purposes, the location 802 of a vehicle, which includes various sensors, is shown in FIGS. 8A and 8B. More specifically, FIG. 8A illustrates a first image 800A, which is a 2D top-view visualization of the geographic region. In this case, the first image 800A refers to an image with relatively well-defined objects, such as a visualization of a scene with simulated objects or a real-world image with annotated objects. The geographic region includes a number of real and detectable objects. For instance, in this non-limiting example, this geographic region includes a number of lanes, which are defined by lane markings (e.g., lane-markings 804A, 806A, 808A, 810A 812A, 814A, 816A, and 818A) and other markings (e.g., stop marker 820A). In addition, this geographic region includes a number of buildings (e.g., a commercial building 822A, a first residential house 824A, a second residential house 826A, a third residential house 828A, and a fourth residential house 830A). This geographic region also includes at least one natural, detectable object (e.g. tree 832A). Also, this geographic region includes a number of mobile objects, e.g., five other vehicles (e.g., vehicles 834A, 836A, 838A, 840A, and 842A) traveling in a first direction, three other vehicles (e.g., vehicles 844A, 846A, and 848A) traveling in a second direction, and two other vehicles (e.g., vehicles 850A and 852A) traveling in a third direction.

FIG. 8B is a diagram of a non-limiting example of a second image 800B, which corresponds to the first image 800A of FIG. 8A according to an example embodiment. In this case, the second image 800B is a top-view visualization of the geographic region, which includes sensor-fusion based objects. In this regard, the second image 800B represents a display of the geographic region with sensor-based representations (e.g., real-world sensor-fusion detections or sensor-fusion detection estimates) of objects. As shown, based on its location 802, the vehicle is enabled, via its various sensors, to provide sensor-fusion building detection 822B for most of the commercial building 822A. In addition, the vehicle is enabled, via its sensors, to provide sensor-fusion home detection 824B and 825B for some parts of two of the residential homes 824A and 825A, but is unable to detect the other two residential homes 828A and 830A. In addition, the vehicle is enabled, via its plurality of sensors and other related data (e.g., map data), to generate indications of lane-markings 804B, 806B, 808B, 810B 812B, 814B, 816B, and 818B and an indication of stop marker 820B except for some parts of the lanes within the intersection. Also, a sensor-fusion tree detection 832B is generated for some parts of the tree 832A. In addition, the sensor-fusion mobile object detections 836B and 846B indicate the obtainment of sensor-based data of varied levels of mobile objects, such as most parts of vehicle 836A, minor parts of vehicle 846B, and no parts of vehicle 834A.

As described herein, the simulation system 100 provides a number of advantageous features, as well as benefits. For example, when applied to the development of an autonomous or a semi-autonomous vehicle 20, the simulation system 100 is configured to provide simulations as realistic input to one or more components of the vehicle 20. For example, the simulation system 100 is configured to provide simulations to a trajectory system, a planning system, a motion control system, a prediction system, a vehicle guidance system, any suitable system, or any combination thereof. Also, by providing simulations with sensor-fusion detection estimates, which are the same as or remarkably similar to real-world sensor-fusion detections that are obtained during real-world drives, the simulation system 100 is configured to contribute to the development of an autonomous or a semi-autonomous vehicle 20 in a safe and cost-effective manner while also reducing safety-critical behavior.

In addition, the simulation system 100 employs a trained machine-learning model, which is advantageously configured for sensor-fusion detection estimation. More specifically, as discussed above, the simulation system 100 includes a trained machine learning model (e.g., GAN. DNN, etc.), which is configured to generate sensor-fusion representations and/or sensor-fusion detection estimates in accordance with how a mobile machine, such as a vehicle 20, would provide such data via a sensor-fusion system during a real-world drive. Although the sensor-fusion detections of objects via a mobile machine varies in accordance with various factors (e.g., distance, sensor locations, occlusion, size, other parameters, or any combination thereof), the trained GAN model is nevertheless trained to generate or predominately contribute to the generation of realistic sensor-fusion detection estimates of these objects in accordance with real-use cases, thereby accounting for these various factors and providing realistic simulations to one or more components of the application system 10.

Furthermore, the simulation system 100 is configured to provide various representations and transformations via the same trained machine-learning model (e.g. trained GAN model), thereby improving the robustness of the simulation system 100 and its evaluation. Moreover, the simulation system 100 is configured to generate a large number of simulations by transforming or generating sensor-fusion representations and/or sensor-fusion detection estimates in place of object data in various scenarios in an efficient and effective manner, thereby leading to faster development of a safer system for an autonomous or semi-autonomous vehicle 20.

That is, the above description is intended to be illustrative, and not restrictive, and provided in the context of a particular application and its requirements. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the general principles defined herein may be applied to other embodiments and applications without departing from the spirit and scope of the described embodiments, and the true scope of the embodiments and/or methods of the present invention are not limited to the embodiments shown and described, since various modifications will become apparent to the skilled practitioner upon a study of the drawings, specification, and following claims. For example, components and functionality may be separated or combined differently than in the manner of the various described embodiments, and may be described using different terminology. These and other variations, modifications, additions, and improvements may fall within the scope of the disclosure as defined in the claims that follow.

What is claimed is:

1. A system for generating a realistic simulation, the system comprising:
a non-transitory computer readable medium including a visualization of a scene that includes a template of a simulation object within a region;
a processing system communicatively connected to the non-transitory computer readable medium, the processing system including at least one processing device and being configured to execute computer readable data that implements a method that includes:
generating a sensor-fusion representation of the template upon receiving the visualization as input; and
generating a simulation of the scene with a sensor-fusion detection estimate of the simulation object instead of the template within the region, the sensor-fusion detection estimate including object contour data indicating bounds of the sensor-fusion representation.

2. The system of claim 1, wherein:
the processing system is configured to generate the sensor-fusion representation of the simulation object via a trained machine-learning model; and
the trained machine-learning model is trained with (i) sensor-fusion data obtained from sensors during real-world drives of vehicles and (ii) annotations identifying object contour data of detections of objects from among the sensor-fusion data.

3. The system of claim 1, wherein:
the processing system is configured to generate a sensor-fusion occupancy map directly from the visualization via a trained generative adversarial network (GAN) model in which the sensor-fusion representation is a part of the sensor-fusion occupancy map; and
the processing system is configured to extract the object contour data based on occupancy criteria of the sensor-fusion occupancy map and provide the object contour data as the sensor-fusion detection estimate.

4. The system of claim 1, wherein the visualization includes a multi-channel pixel image in which the simulation object is in a channel for simulation objects that is distinct from the other channels.

5. The system of claim 1, wherein:
the processing system is configured to receive location data of the simulation object as input along with the visualization to generate the sensor-fusion representation of the simulation object via a trained generative adversarial network (GAN) model; and
the sensor-fusion representation includes object contour data that serves as the sensor-fusion detection estimate.

6. The system of claim 1, wherein the visualization includes a two-dimensional top view of the simulation object within the region.

7. The system of claim 1, wherein the sensor-fusion representation is based on a plurality of sensors including at least a camera, a satellite-based sensor, a light detection and ranging sensor, and a radar sensor.

8. A computer-implemented method comprising:
obtaining, via a processing system with at least one computer processor, a visualization of a scene that includes a template of a simulation object within a region;
generating, via the processing system, a sensor-fusion representation of the template upon receiving the visualization as input; and
generating, via the processing system, a simulation of the scene with a sensor-fusion detection estimate of the simulation object instead of the template within the region, the sensor-fusion detection estimate including object contour data indicating bounds of the sensor-fusion representation.

9. The method of claim 8, wherein the sensor-fusion representation of the simulation object is generated via employing a trained machine-learning model; and
the trained machine-learning model is trained with at least (i) sensor-fusion data obtained from sensors during real-world drives of vehicles and (ii) annotations identifying object contour data of detections of objects from among the sensor-fusion data.

10. The method of claim 8, wherein:
the step of generating the sensor-fusion representation of the template upon receiving the visualization as input includes generating a sensor-fusion occupancy map via a trained generative adversarial network (GAN) model in which the sensor-fusion representation is generated as a part of the sensor-fusion occupancy map;
the object contour data is extracted based on occupancy criteria of the sensor-fusion occupancy map; and
the object contour data is provided as the sensor-fusion detection estimate.

11. The method of claim 8, wherein the visualization includes a multi-channel pixel image in which the simulation object is in a channel for simulation objects that is distinct from the other channels.

12. The method of claim 8, further comprising:
obtaining location data of the simulation object as input along with the visualization to generate the sensor-fusion representation of the simulation object via a trained generative adversarial network (GAN) model;
wherein:
the sensor-fusion representation includes object contour data that serves as the sensor-fusion detection estimate.

13. The method of claim 8, wherein the visualization includes a two-dimensional top view of the simulation object within the region.

14. The method of claim 8, wherein the sensor-fusion representation is based on a plurality of sensors including at least a camera, a satellite-based sensor, a light detection and ranging sensor, and a radar sensor.

15. A non-transitory computer readable medium with computer-readable data that, when executed by a computer processor, is configured to implement a method comprising:
obtaining visualization of a scene that includes a template of a simulation object within a region;
generating a sensor-fusion representation of the template upon receiving the visualization as input; and
generating a simulation of the scene with a sensor-fusion detection estimate of the simulation object instead of the template within the region, the sensor-fusion detection estimate including object contour data indicating bounds of the sensor-fusion representation.

16. The computer readable medium of claim 15, wherein:
the sensor-fusion representation of the simulation object is generated via a trained machine-learning model; and
the trained machine-learning model is trained with (i) sensor-fusion data obtained from sensors during real-world drives of vehicles and (ii) annotations identifying object contour data of detections of objects from among the sensor-fusion data.

17. The computer readable medium of claim 15, wherein the method includes:
generating a sensor-fusion occupancy map via a trained generative adversarial network (GAN) model in which the sensor-fusion representation is a part of the sensor-fusion occupancy map;
extracting object contour data based on occupancy criteria of the sensor-fusion occupancy map; and
providing the object contour data as the sensor-fusion detection estimate.

18. The computer readable medium of claim 15, wherein the visualization includes a multi-channel pixel image in which the simulation object is in a channel for simulation objects that is distinct from the other channels.

19. The computer readable medium of claim 15, wherein the method includes:
obtaining location data of the simulation object as input along with the visualization to generate the sensor-fusion representation of the simulation object via a trained generative adversarial network (GAN) model; and
the sensor-fusion representation includes object contour data as the sensor-fusion detection estimate.

20. The computer readable medium of claim 15, wherein the visualization is a two-dimensional top view of the simulation object within the region.
